(19) United States
(12) Patent Application Publication
(10) Pub. No.: US 2004/0018070 A1
(43) Pub. Date: Jan. 29, 2004

(54) Compact and high throughput semiconductor fabrication system

(75) Inventors: Jun Zhao, Cupertino, CA (US); Satish Sundar, Milpitas, CA (US); Vinay K. Shah, San Francisco, CA (US); Hari K. Ponnekanti, San Jose, CA (US); Mario Dave Silvetti, Morgan Hill, CA (US); Michael Robert Rice, Pleasanton, CA (US); Avi Tepman, Cupertino, CA (US); Farhad K. Moghadam, Saratoga, CA (US)

Correspondence Address: APPLIED MATERIALS, INC., P.O. Box 450A, Santa Clara, CA, 95054, US

(73) Assignee: APPLIED MATERIALS, INC., Santa Clara, CA (US)

(21) Appl. No.: 10/206,724

(22) Filed: Jul. 25, 2002

(51) Int. Cl. B65G 49/07

(52) U.S. Cl. 414/217

(57) ABSTRACT

Embodiments of the present invention are directed to substrate processing systems having substrate transferring mechanisms that are compact, have small footprints, and provide fast and efficient substrate transfer to achieve high throughput. In specific embodiments, a unit slab construction is used for the chambers around the substrate transferring mechanism, enabling efficient system construction with improved alignment and at a lower cost. The chambers may share gas, pump, and other utilizes. In one embodiment, an apparatus for processing substrates includes at least three robot blades each configured to support a substrate. A robot is coupled with the at least three robot blades to simultaneously move the robot blades between at least three chambers and simultaneously transfer each of the substrates supported on the robot blades from one chamber to another chamber.

### BACKGROUND OF THE INVENTION

The present invention relates generally to substrate processing and, more particularly, to a system for transferring substrates between a plurality of chambers for processing the substrates.

During the processing of substrates in semiconductor manufacturing, for example, a number of different operations are performed on the substrates. Most of these operations are performed in vacuum chambers, and the substrates are often moved between different chambers for carrying out different processes. An inefficient substrate handling design can adversely and severely impact throughput. Achieving higher throughput at a lower cost is an objective for designing substrate transferring and processing systems.

### BRIEF SUMMARY OF THE INVENTION

Embodiments of the present invention are directed to substrate processing systems having substrate transferring mechanisms that are compact, have small footprints, and provide fast and efficient substrate transfer to achieve high throughput. In specific embodiments, a unit slab construction is used for a plurality of chambers around the substrate transferring mechanism, enabling efficient system construction with improved alignment and at a lower cost. The plurality of chambers may share common gas lines, exhaust lines, and other elements, and may utilize single wafer load lock (SWLL) preheating techniques to reduce process overhead. Embodiments of the invention are able to achieve ultra high throughput (>120 substrates per hour) for some thin film processes including those with relatively short process time (e.g., <1 minute per substrate).

In one embodiment, an apparatus for processing substrates includes at least three robot blades each configured to support a substrate. A robot is coupled with the at least three robot blades to simultaneously move the robot blades between at least three chambers and simultaneously transfer each of the substrates supported on the robot blades from one chamber to another chamber.

In some embodiments, the at least three robot blades are angularly spaced from each other, and the robot is configured to simultaneously move each of the robot blades angularly from one chamber to another chamber. The substrates are placed into separate chambers. The robot includes a positional actuator and a placement actuator representing two degrees of freedom of movement. The positional actuator is configured to simultaneously move each of the robot blades from a position oriented toward a chamber to another position oriented toward another chamber. The placement actuator is configured to simultaneously move each of the robot blades into and out of a chamber to which each of the robot blades is oriented. In specific embodiments, the positional actuator is configured to rotate the robot blades from one chamber to another chamber, and the placement actuator is configured to extend the robot blades into and retract them from the chambers.

In another embodiment, a substrate processing apparatus comprises a first robot blade, a second robot blade, a third robot blade, and a fourth robot blade. Each robot blade is configured to support a substrate. A robot is coupled to the first robot blade and the second robot blade to simultaneously move the first and second robot blades between a first chamber and a second chamber to exchange positions of the first and second robot blades between the first and second chambers. The robot is coupled to the third robot blade and the fourth robot blade to simultaneously move the third and fourth robot blades between a third chamber and a fourth chamber to exchange positions of the third and fourth robot blades between the third and fourth chambers.

In some embodiments, the robot is configured to simultaneously move the first robot blade, the second robot blade, the third robot blade, and the fourth robot blade. The chambers are disposed around the robot. The first and second chamber are disposed on opposite sides of the robot, while the third and fourth chamber are disposed on opposite sides of the robot.

In still another embodiment, a method of processing substrates comprises supporting a plurality of substrates separately on at least three robot blades, and simultaneously moving the robot blades between at least three chambers and simultaneously transferring each of the substrates supported on the robot blades from one chamber to another chamber. A semiconductor manufacturing operation is performed on the substrate in at least one of the chambers.

### BRIEF DESCRIPTION OF THE DRAWINGS

FIG. 1 is a perspective view of a substrate processing system according to an embodiment of the present invention, showing a substrate transfer mechanism placing substrates inside chambers;

FIG. 2 is a perspective view of the substrate processing system of FIG. 1 showing the substrate transfer mechanism moving substrates between chambers;

FIG. 3 is a perspective view of the substrate processing system of FIG. 2 showing the substrate transfer mechanism placing the substrates inside different chambers after retrieving them from the original chambers;

FIG. 4 is a perspective view of a substrate processing system according to another embodiment of the present invention, showing a substrate transfer mechanism placing substrates inside chambers with extended robot blades;

FIG. 5 is a perspective view of the substrate transfer mechanism of FIG. 4 showing retracted robot blades of the substrate transfer mechanism to remove substrates from the chambers;

FIG. 6 is a top plan view of the substrate transfer mechanism of FIG. 5;

FIG. 7 is an elevational view of a part of the substrate transfer mechanism of FIG. 5;

FIG. 8 is a perspective view of the substrate processing system of FIG. 5 showing the substrate transfer mechanism placing the substrates inside different chambers after retrieving them from the original chambers;

FIG. 9 is a top plan view of a substrate transfer mechanism placing substrates inside chambers according to another embodiment of the present invention;

FIG. 10 is a top plan view of the substrate transfer mechanism of FIG. 9 showing retracted robot blades of the substrate transfer mechanism to remove substrates from the chambers; and

FIG. 11 is a top plan view of the substrate transfer mechanism of FIG. 10 showing the substrate transfer mechanism placing the substrates inside different chambers after retrieving them from the original chambers.

### DETAILED DESCRIPTION OF THE INVENTION

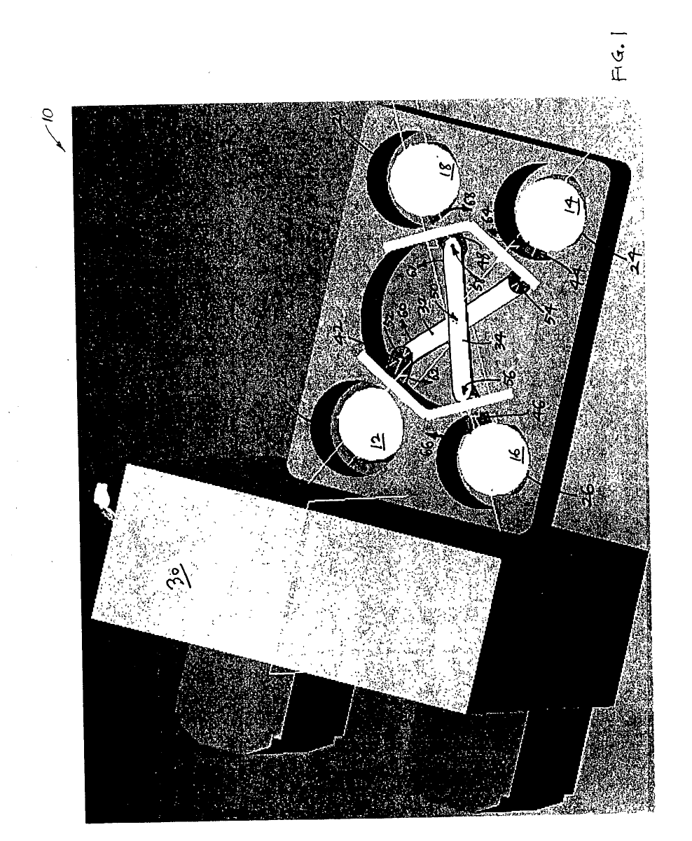

FIGS. 1-3 show one embodiment of a substrate processing apparatus 10 for simultaneously processing a plurality of substrates. FIG. 1 shows four substrates 12, 14, 16, 18 placed in four separate chambers 22, 24, 26, 28. The tops of the chambers are removed to show the substrates. The different chambers may be configured to perform different operations on the substrates. In one example, the chambers 22, 26 are load lock chambers. A substrate handling station 30 includes a mechanism for transferring substrates between the load lock chambers 22, 26 and cassettes or other storage devices disposed in the handling station 30. The other two chambers 24, 28 may be configured to perform any desirable operations on the substrates disposed therein such as semiconductor manufacturing operations including, for example, chemical vapor deposition, plasma vapor deposition, epitaxial layer deposition, etching, ion implantation, and the like. The two chambers 24, 28 may be configured to perform the same operation or different operations on the substrates disposed therein.

The four substrates are transferred between the four chambers. In the specific configuration shown in FIGS. 1-3, the substrates are transferred diagonally. The substrates 12, 14 are exchanged between the chambers 22, 24, while the substrates 16, 18 are exchanged between the chambers 26, 28. In some embodiments, the exchange of the substrates 12, 14 between the chambers 22, 24 occurs simultaneously, and the exchange of the substrates 16, 18 between the chambers 26, 28 occurs simultaneously. In a specific embodiment, the exchange of the substrates 12, 14 and the exchange of the substrate 16, 18 take place simultaneously.

A robotic system is used to transfer the substrates between the four chambers. As shown in FIGS. 1-3, the robotic system includes two robot arms 32, 34. The robot arm 32 is coupled with two robot blades 42, 44, which support the substrates 12, 14, respectively. The robot arm 34 is coupled with two robot blades 46, 48, which support the substrates 16, 18, respectively. The robot arms 32, 34 are rotatable with respect to a central axis 50. In the embodiment shown, the robot blades 42, 44 are rotatably coupled with the robot arm 32 at pivot points 52, 54, respectively. The robot blades 46, 48 are rotatably coupled with the robot arm 34 at pivot points 56, 58, respectively.

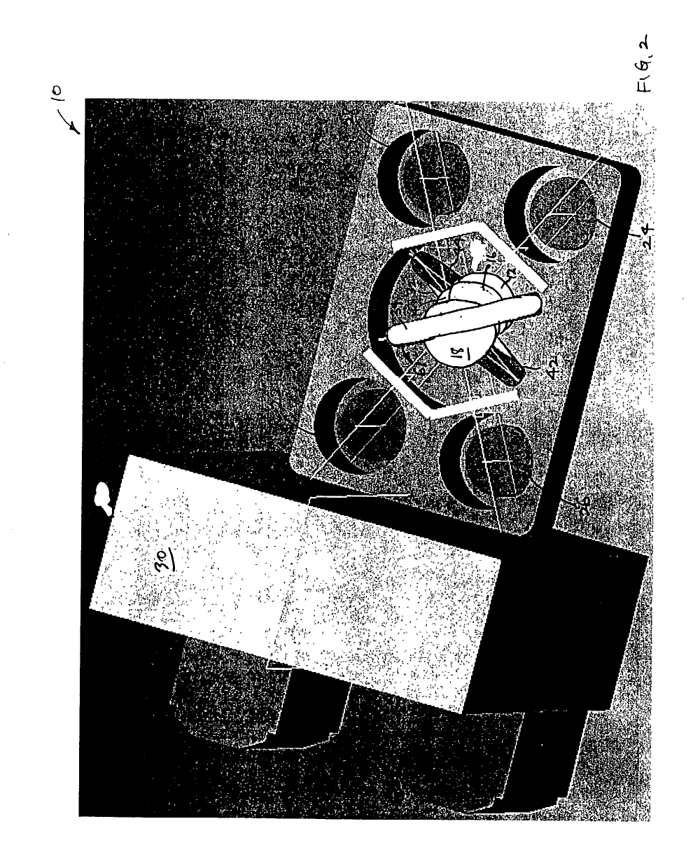

As shown in FIGS. 1 and 2, the robot arm 32 is rotated in direction 60, and the robot arm 34 is rotated in direction 61. The rotation of the robot arm 32 in direction 60, coupled with the rotation of the robot blades 42, 44 in directions 62, 64, respectively, relative to the robot arm 32, retrieves the substrates 12, 14 from the chambers 22, 24. The robot blades 42, 44 are in a retracted position in FIG. 2 as opposed to the extended position of FIG. 1. The rotation of the robot arm 34, coupled with the rotation of the robot blades 46, 48 in directions 66, 68, respectively, relative to the robot arm 34, retrieves the substrates 16, 18 from the chambers 26, 28. The robot blades 46, 48 are in a retracted position as opposed to the extended position of FIG. 1.

In FIG. 3, the robot arm 32 has been rotated by about 180°, and the robot blades 42, 44 have been rotated relative to the robot arm 32 also by about 180° to an extended position to place the substrate 14 in the chamber 22 and the substrate 12 in the chamber 24. The robot arm 34 has been rotated by about 180°, and the robot blades 46, 48 have been rotated relative to the robot arm 34 also by about 180° to an extended position to place the substrate 18 in the chamber 26 and the substrate 16 in the chamber 28. The substrate 16 is processed in the chamber 28, and the substrate 12 is processed in the chamber 24. The substrates 14, 18 in the load lock chambers 22, 26 may be replaced by fresh substrates supplied through the substrate handling station 30.

Subsequent to the transfer of substrates as shown in FIGS. 1-3, to exchange the substrates between the chambers 22, 24, the robot arm 32 is rotated in a direction opposite from the direction 60 of FIGS. 1 and 2 by about 180° until the robot arm 32 is returned to the same position as shown in FIG. 1. The robot blades 42, 44 are rotated in directions opposite from the directions 62, 64 of FIGS. 1 and 2. To exchange the substrates between the chambers 26, 28, the robot arm 34 is rotated in a direction opposite from the direction 61 of FIGS. 1 and 2 by about 180° until the robot arm 34 is returned to the same position as shown in FIG. 1. The robot blades 46, 48 are rotated in directions opposite from the directions 66, 68 of FIGS. 1 and 2. In other embodiments, the robot arms 32, 34 may continue rotating in their respective directions 60, 61 (as from FIG. 1 via FIG. 2 to FIG. 3), provided that the robot blades 42, 44 are appropriately rotated with respect to the robot arms 32, 34 to move in and out of the chambers 22, 24.

The robot system used to control the rotation of the robot arms 32, 34 and robot blades 42, 44, 46, 48 may employ various mechanical linkages, gears, or the like, and various mechanical and/or electronic control devices to synchronize the movements thereof. These devices and components can be configured by those of skill in the art to achieve the substrate transfer process described herein.

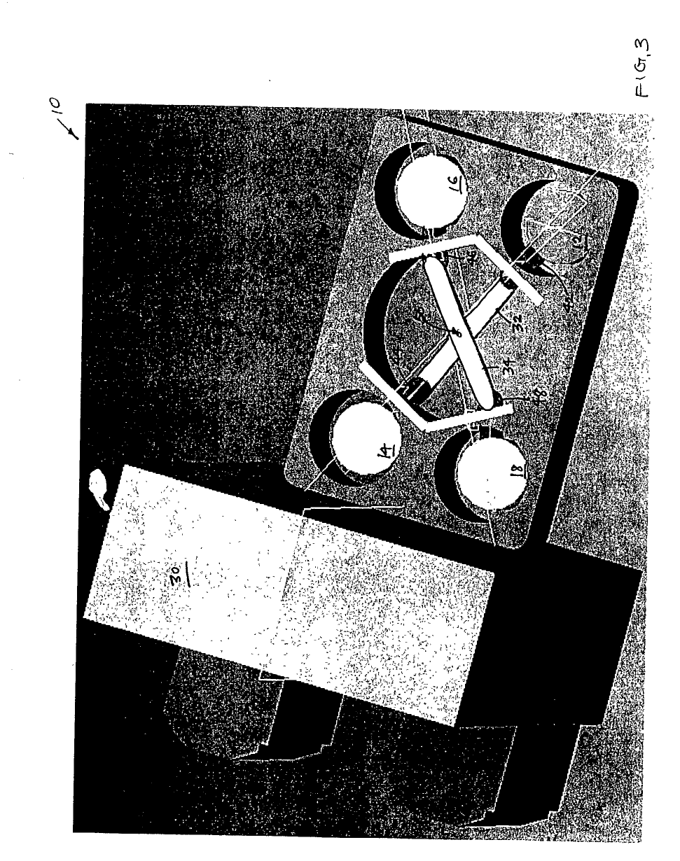

FIGS. 4-8 show another substrate processing apparatus 10 for simultaneously processing a plurality of substrates. Four substrates (not shown) are placed in four separate chambers 122, 124, 126, 128. The four substrates are transferred between the four chambers diagonally. In specific embodiments, the transfers of substrates between the four chambers occur simultaneously.

A robotic system is used to transfer the substrates between the four chambers. As shown in FIGS. 4-8, the robotic system has a substrate handling station 130, and includes a robot arm or platform 132. Four robot blades 142, 144, 146, 148 are rotatably coupled with the robot arm 132, and are used to support the substrates. The robot arm 132 is rotatable with respect to a central axis 150. In the embodiment shown, the robot blades 142, 144, 146, 148 are rotatably coupled with the robot arm 132 at pivot points 152, 154, 156, 158, respectively.

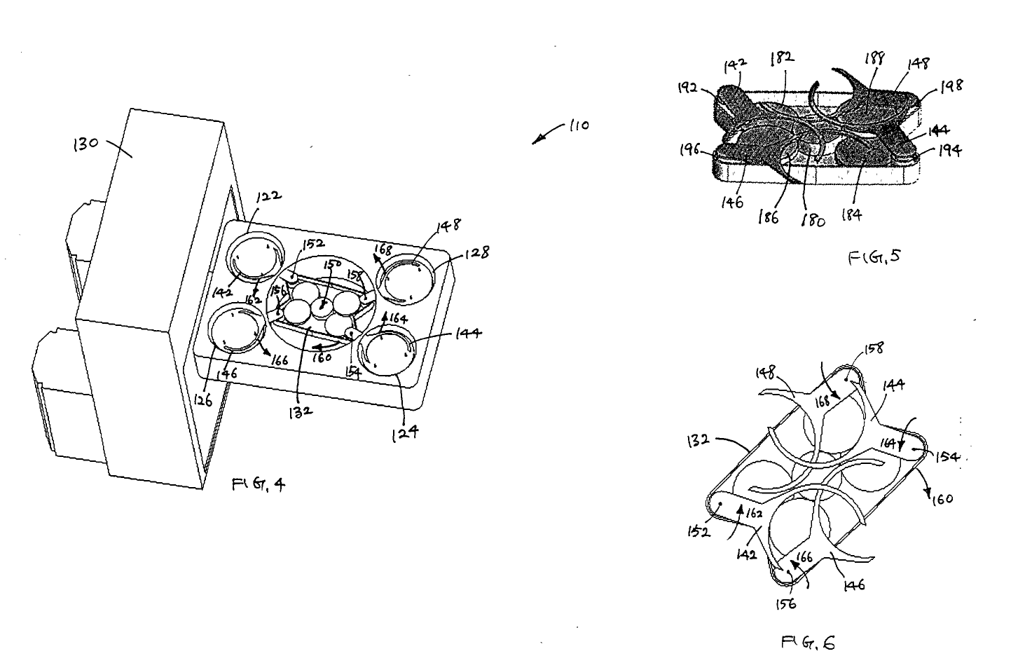

As shown in FIGS. 4 and 6, the robot arm 132 is rotated in direction 160. The robot blades 142, 144, 146, 148 are rotated relative to the robot arm 132 in directions 162, 164, 166, 168, respectively. The rotation of the robot arm 132 in direction 160, coupled with the rotation of the robot blades 142, 144, 146, 148 in directions 162, 164, 166, 168, respectively, relative to the robot arm 132, retrieves the substrates from the chambers 122, 124, 126, 128. The robot blades 142, 144, 146, 148 are in a retracted position in FIGS. 5 and 6 as opposed to the extended position of FIG. 4.

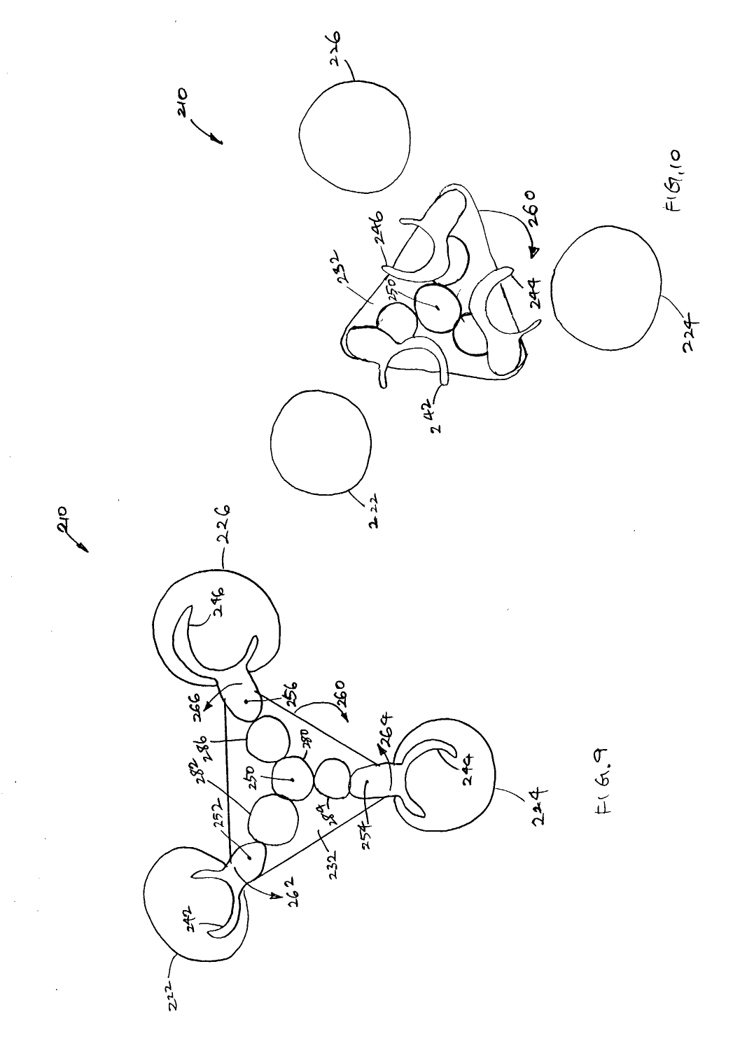

In FIG. 8, the robot arm 132 has been rotated by about 180°, so that the robot blade 142 is disposed adjacent the chamber 124, the robot blade 144 is disposed adjacent the chamber 122, the robot blade 146 is disposed adjacent the chamber 128, and the robot blade 148 is disposed adjacent the chamber 126. The robot blade 142 is rotated in a direction 162′ opposite from direction 162; the robot blade 144 is rotated in a direction 164′ opposite from direction 164; the robot blade 146 is rotated in a direction 166′ opposite from direction 166, and the robot blade 148 is rotated in a direction 168′ opposite from direction 168. These opposite rotations of the robot blades 162, 164, 166, 168 relative to the robot arm 132 move the robot blades to an extended position to place the substrate in the chambers 124, 122, 128, 126, respectively. The substrates in the chambers 124, 128 may be subjected to the same or different manufacturing operations. The substrates 144, 148 in the load lock chambers 122, 126 may be replaced by fresh substrates supplied through the substrate handling station 130.

Subsequent to the transfer of substrates as shown in FIGS. 4-8, to exchange the substrates between the chambers 122, 124 and to exchange the substrates between the chambers 126, 128, the robot arm 132 may be rotated in the same direction 160 by about 180° or in a direction opposite from the direction 160 by about 180° until the robot arm 132 is returned to the same position as shown in FIG. 4. The rotation of the robot blades 142, 144, 146, 148 are similar to those shown in FIGS. 4-8 and described above.

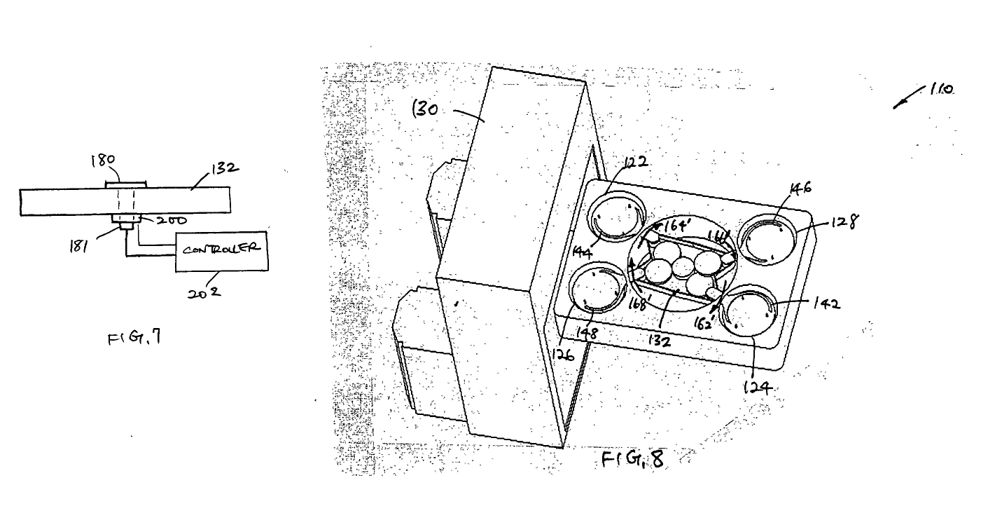

The robot system used to control the rotation of the robot arm 132 and robot blades 142, 144, 146, 148 may employ various mechanical linkages, gears, or the like, and various mechanical and/or electronic control devices to synchronize the movements thereof. FIGS. 5 and 7 show in further detail the use of a gear system and actuators to effect the desired rotations of the robotic components.

FIGS. 5 and 7 show a central drive gear 180 which is driven in rotation by a gear actuator 181. Four intermediate gears 182, 184, 186, 188 are driven by the drive gear 180 to rotate in a direction opposite from the rotation of the drive gear 180. The rotations of the intermediate gears 182, 184, 186, 188 cause four distal gears 192, 194, 196, 198 to rotate, respectively, in the same direction as the drive gear 180. The four distal gears 192, 194, 196, 198 are attached with the four robot blades 142, 144, 146, 148, respectively, so that they rotate in the same direction as the drive gear 180. The amount of rotation of the robot blades depends on the gear ratios from the drive gear 180 via the intermediate gears 182, 184, 186, 188, to the distal gears 192, 194, 196, 198. A robot arm actuator 200 is used to rotate the robot arm 132. The gear actuator 181 and the robot arm actuator 200 are controlled by a controller 202 to move the robot blades and manipulate the substrates in the desired manner. The controller 202 may include mechanical components, electronic components, or both.

FIGS. 9-11 show another embodiment of the substrate processing apparatus 210 for processing three substrates (not shown) to be moved in and out of three chambers 222, 224, 226. In specific embodiments, a robotic system is used to transfer the substrates between the three chambers simultaneously. The chambers 222, 224, 226 may perform the same or different operations on the substrates disposed therein. One of the chambers may be a load lock chamber.

As shown in FIGS. 9-11, the robotic system includes a robot arm or platform 232. Three robot blades 242, 244, 246 are rotatably coupled with the robot arm 232, and are used to support the substrates. The robot arm 232 is rotatable with respect to a central axis 250. In the embodiment shown, the robot blades 242, 244, 246 are rotatably coupled with the robot arm 232 at pivot points 252, 254, 256, respectively.

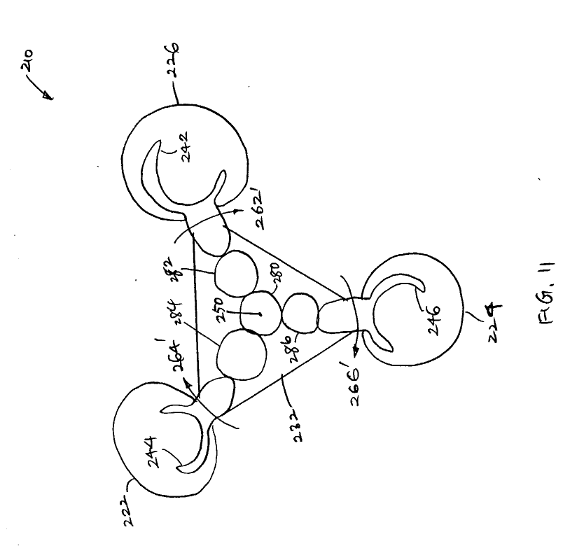

The robot arm 232 is rotated in direction 260. The robot blades 242, 244, 246 are rotated relative to the robot arm 232 in directions 262, 264, 266, respectively. The rotation of the robot arm 232 in direction 260, coupled with the rotation of the robot blades 242, 244, 246 in directions 262, 264, 266, respectively, relative to the robot arm 232, retrieves the substrates from the chambers 222, 224, 226. The robot blades 242, 244, 246 are in a retracted position in FIG. 10 as opposed to the extended position of FIG. 9.

In FIG. 11, the robot arm 232 has been rotated by about 120°, so that the robot blade 242 is disposed adjacent the chamber 226, the robot blade 244 is disposed adjacent the chamber 222, and the robot blade 246 is disposed adjacent the chamber 224. The robot blade 242 is rotated in a direction 262′ opposite from direction 262; the robot blade 244 is rotated in a direction 264′ opposite from direction 264; and the robot blade 246 is rotated in a direction 266′ opposite from direction 266. These opposite rotations of the robot blades 262, 264, 266 relative to the robot arm 232 move the robot blades to an extended position to place the substrate in the chambers 226, 222, 224, respectively.

Subsequent to the transfer of substrates as shown in FIGS. 9-11, the substrates may be further moved by rotating the robot arm 232 in the direction 260 or in an opposite direction. In the direction 260, the substrates may be moved between the three chambers 222, 224, 226 to be processed in each chamber sequentially. One chamber may be a load lock chamber, and the other two chambers may perform different operations on the substrate disposed therein in sequence. Alternatively, the substrates may be moved back to the original chambers (from FIG. 11 back to FIG. 9) by moving the robot arm 232 either in the direction 260 or in the opposite direction.

The robot system used to control the rotation of the robot arm 232 and robot blades 242, 244, 246 may employ various mechanical linkages, gears, or the like, and various mechanical and/or electronic control devices to synchronize the movements thereof. In the embodiment illustrated in FIGS. 9-11, a gear arrangement similar to that shown in FIGS. 4-8 is employed. The gear arrangement includes a central drive gear 280 for driving three intermediate gears 282, 284, 286, which in turn drive three distal gears 292, 294, 296 that are attached with the three robot blades 242, 244, 246, respectively. The drive gear 280 is driven by a gear actuator, and a robot arm actuator is used to rotate the robot arm 232. The actuators are controlled by a controller to move the robot blades and manipulate the substrates in the desired manner. The substrate processing system 210 may be modified to transfer and process substrates between four or more chambers. Processing substrates in the different chambers can achieve wafer-to-wafer uniformity averaging.

The substrate transfer mechanisms of the present invention achieve small footprints. The mechanisms are compact, and provide fast substrate transfer to achieve high throughput. A unit slab construction may be used for the chambers, enabling efficient system construction with improved alignment and at a lower cost. The chambers may share gas, pump, and other utilities. Examples of utility sharing among chambers can be found in commonly assigned U.S. Pat. No. 5,855,681, entitled “Ultra High Throughput Wafer Vacuum Processing System,” issued Jan. 5, 1999, the entire disclosure of which is incorporated herein by reference. Utilizing preheat single wafer load lock (SWLL), the system can reduce process overhead to achieve ultra high throughput (e.g., >120 substrates per hour) for thin film process and for short process time (e.g., <1 minute per substrate).

It is to be understood that the above description is intended to be illustrative and not restrictive. Many embodiments will be apparent to those of skill in the art upon reviewing the above description. By way of example, the number and arrangement of the chambers and robot blades may be modified. The scope of the invention should, therefore, be determined not with reference to the above description, but instead should be determined with reference to the appended claims along with their full scope of equivalents.

What is claimed is:

1. An apparatus for processing substrates, the apparatus comprising:
at least three robot blades each configured to support a substrate; and
a robot coupled with the at least three robot blades to simultaneously move the at least three robot blades between at least three chambers and simultaneously transfer each of the substrates supported on the at least three robot blades from one chamber to another chamber.

2. The apparatus of claim 1 wherein the robot is coupled with four robot blades to simultaneously move the four robot blades between a plurality of chambers and simultaneously transfer substrates supported on the robot blades between the plurality of chambers.

3. The apparatus of claim 2 wherein the robot is configured to simultaneously move, a first robot blade and a second robot blade between a first chamber and a second chamber to exchange positions of the first robot blade and the second robot blade between the first chamber and the second chamber, and a third robot blade and a fourth robot blade between a third chamber and a fourth chamber to exchange positions of the third robot blade and the fourth robot blade between the third chamber and the fourth chamber.

4. The apparatus of claim 1 wherein the at least three robot blades are angularly spaced from each other, and wherein the robot is configured to simultaneously move each of the at least three robot blades angularly from one chamber to another chamber.

5. The apparatus of claim 1 wherein the robot comprises a positional actuator and a placement actuator, the positional actuator being configured to simultaneously move each of the robot blades from a position oriented toward a chamber to another position oriented toward another chamber, the placement actuator being configured to simultaneously move each of the robot blades into and out of a chamber to which each of the robot blades is oriented.

6. The apparatus of claim 5 wherein the positional actuator is a rotational actuator.

7. The apparatus of claim 5 wherein the placement actuator is a rotational actuator.

8. The apparatus of claim 7 wherein the placement actuator is coupled with the robot blades by gears.

9. The apparatus of claim 1 wherein the robot moves the at least three robot blades to simultaneously transfer each of the substrates supported on the at least three robot blades into separate chambers.

10. A substrate processing apparatus comprising:
a first robot blade, a second robot blade, a third robot blade, and a fourth robot blade, each robot blade being configured to support a substrate; and
a robot;
wherein the robot is coupled to the first robot blade and the second robot blade to simultaneously move the first robot blade and the second robot blade between a first chamber and a second chamber to exchange positions of the first robot blade and the second robot blade between the first chamber and the second chamber;
wherein the robot is coupled to the third robot blade and the fourth robot blade to simultaneously move the third robot blade and the fourth robot blade between a third chamber and a fourth chamber to exchange positions of the third robot blade and the fourth robot blade between the third chamber and the fourth chamber.

11. The apparatus of claim 10 wherein the robot is configured to simultaneously move the first robot blade, the second robot blade, the third robot blade, and the fourth robot blade.

12. The apparatus of claim 10 wherein the chambers are disposed around the robot, the first and second chamber being disposed on opposite sides of the robot, the third and fourth chamber being disposed on opposite sides of the robot.

13. The apparatus of claim 10 wherein the robot comprises a first robot arm and a second robot arm, the first robot arm being connected with the first robot blade and the second robot blade and being rotatable to move the first robot blade and the second robot blade between the first chamber and the second chamber; the second robot arm being connected with the third robot blade and the fourth robot blade and being rotatable to move the third robot blade and the fourth robot blade between the third chamber and the fourth chamber.

14. The apparatus of claim 13 wherein the first and second robot blades are rotatably connected with the first robot arm to rotate relative to the first robot arm, and the third and fourth robot blades are rotatably connected with the second robot arm to rotate relative to the second robot arm.

15. An apparatus for processing substrates, the apparatus comprising:
at least three robot blades each configured to support a substrate; and
a robot coupled with the at least three robot blades to simultaneously move the at least three robot blades between at least three chambers disposed around the robot, and to simultaneously transfer each of the substrates supported on the at least three robot blades from one chamber to an adjacent chamber disposed adjacent to the one chamber.

16. The apparatus of claim 15 wherein the robot comprises a positional actuator and a placement actuator, the positional actuator being configured to simultaneously move each of the robot blades from a position oriented toward one chamber to another position oriented toward the adjacent chamber, the placement actuator being configured to simultaneously move each of the robot blades into and out of a separate chamber to which each of the robot blades is oriented.

17. The apparatus of claim 16 wherein the positional actuator is configured to move a positional robot arm in rotation, wherein the robot blades are coupled to the positional robot arm to be moved by the positional actuator simultaneously, and wherein the placement actuator is configured to move the robot blades relative to the positional robot arm into and out of the separate chambers.

18. The apparatus of claim 17 wherein the robot blades are rotatably coupled to the positional robot arm, and wherein the placement actuator is configured to move the robot blades in rotation relative to the positional robot arm into and out of the separate chambers.

19. A method of processing substrates, the method comprising:
supporting a plurality of substrates separately on at least three robot blades;
simultaneously moving the at least three robot blades between at least three chambers and simultaneously transferring each of the substrates supported on the at least three robot blades from one chamber to another chamber; and
performing a semiconductor manufacturing operation on the substrate in at least one of the chambers.

20. The method of claim 19 wherein the semiconductor manufacturing operation is selected from the group consisting of chemical vapor deposition, plasma vapor deposition, epitaxial layer deposition, etching, and ion implantation.

21. The method of claim 19 wherein a first robot blade and a second robot blade are simultaneously moved between a first chamber and a second chamber to exchange positions of the first robot blade and the second robot blade between the first chamber and the second chamber, and wherein a third robot blade and a fourth robot blade are simultaneously moved between a third chamber and a fourth chamber to exchange positions of the third robot blade and the fourth robot blade between the third chamber and the fourth chamber.

22. The method of claim 19 wherein the at least three robot blades are moved simultaneously between at least three chambers disposed around a central region, to simultaneously transfer each of the substrates supported on the at least three robot blades from one chamber to an adjacent chamber disposed adjacent to the one chamber.

23. The method of claim 22 wherein the at least three robot blades are moved simultaneously to simultaneously transfer each of the substrates supported on the at least three robot blades into and out of a separate chamber.
